(19) United States
(12) Patent Application Publication
(10) Pub. No.: US 2009/0052621 A1
(43) Pub. Date: Feb. 26, 2009

(54) METHOD AND APPARATUS FOR BASIS MATERIAL DECOMPOSITION WITH K-EDGE MATERIALS

(76) Inventors: Deborah Joy Walter, Terre Haute, IN (US); Xiaoye Wu, Rexford, NY (US); John Eric Tkaczyk, Delanson, NY (US); Yanfeng Du, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/843,700

(22) Filed: Aug. 23, 2007

(51) Int. Cl. G01N 23/06

(52) U.S. Cl. 378/53

(57) ABSTRACT

A diagnostic imaging system includes a high frequency electromagnetic energy source that emits a beam of high frequency electromagnetic energy toward an object to be imaged, a detector that receives high frequency electromagnetic energy emitted by the high frequency electromagnetic energy source, and a data acquisition system (DAS) operably connected to the detector. A computer is operably connected to the DAS and is programmed to generate corresponding sets of projection values for three or more energy spectra through employment of attenuation coefficients of three or more basis materials to simulate responses of the diagnostic imaging system to a plurality of lengths of the three or more basis materials wherein the three or more basis materials comprise two or more non K-edge basis materials and one or more K-edge basis materials.

### BACKGROUND OF THE INVENTION

The present invention relates generally to diagnostic imaging and, more particularly, to a method and apparatus of computed tomography imaging systems and basis material decomposition within such systems.

Exemplary diagnostics devices comprise x-ray systems, magnetic resonance (MR) systems, ultrasound systems, computed tomography (CT) systems, positron emission tomography (PET) systems, and other types of imaging systems. Typically, in CT imaging systems, an x-ray source emits a fan-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

Generally, the x-ray source and the detector array are rotated about the gantry opening within an imaging plane and around the subject. X-ray sources typically include x-ray tubes, which emit the x-ray beam at a focal point. X-ray detectors typically include a collimator for collimating x-ray beams received at the detector, a scintillator for converting x-rays to light energy adjacent the collimator, and photodiodes for receiving the light energy from the adjacent scintillator and producing electrical signals therefrom.

Typically, each scintillator of a scintillator array converts x-rays to light energy. Each scintillator discharges light energy to a photodiode adjacent thereto. Each photodiode detects the light energy and generates a corresponding electrical signal. The outputs of the photodiodes are then transmitted to the data processing system for image reconstruction.

An exemplary CT imaging system comprises an energy discriminating (ED), multi energy (ME), and/or dual energy (DE) CT imaging system that may be referred to as an EDCT, MECT, and/or DECT imaging system. A system that measures at two energy ranges is commonly known as DECT. An EDCT or an MECT system may measure at two or more energy ranges. The EDCT, MECT, and/or DECT imaging system in an example is configured to be responsive to different x-ray spectra. For example, a conventional third generation CT system acquires projections sequentially at different x-ray tube potentials. Two scans in an example are acquired either back to back or interleaved in which the tube operates at 80 kVp and 160 kVp potentials. Special filters in an example are placed between the x-ray source and the detector such that different detector rows collect projections of different x-ray energy spectra. The special filters that shape the x-ray spectrum in an example can be used for two scans that are acquired either back to back or interleaved. Energy sensitive detectors in an example are used such that each x-ray photon reaching the detector is recorded with its photon energy.

Exemplary ways to obtain the measurements comprise: (1) scan with two distinctive energy spectra, (2) detect photon energy according to energy deposition in the detector, and (3) photon counting. EDCT/MECT/DECT provides energy discrimination and material characterization. For example, in the absence of object scatter, the system derives the behavior at any other energy based on the signal from two regions of photon energy in the spectrum: the low-energy and the high-energy portions of the incident x-ray spectrum. In an exemplary energy region of medical CT, two physical processes dominate the x-ray attenuation: (1) Compton scatter and the (2) photoelectric effect. The detected signals from two energy regions provide sufficient information to resolve the energy dependence of the material being imaged. Furthermore, detected signals from the two energy regions provide sufficient information to determine the relative composition of an object composed of two materials.

The conventional basis material decomposition (BMD) algorithm is based on the concept that, in the energy region for medical CT, the x-ray attenuation of any given material can be represented by a proper density mix of two other materials, referred to as the basis materials. Based on the projections acquired at the two incident x-ray spectra, the BMD algorithm computes two sets of new projections, corresponding to two new CT images that each represents the equivalent density of one of the basis materials. Since a material density is independent of x-ray photon energy, these images are approximately free of beam-hardening artifacts. An operator can choose the basis material to target a certain material of interest, for example, to enhance the image contrast.

Medical CT images can be enhanced in certain applications by use of contrast agents. A contrast agent is injected and images can be taken below and above the K-edge absorption energy of the contrast agent to further the contrast agent. For example, the two images are logarithmically subtracted and show the details of the structure of those volumes containing the contrast agent.

A K-edge indicates a sudden increase in the attenuation coefficient of photons occurring at a photon energy just above the binding energy of a K shell electron of the atoms interacting with the photons. The sudden increase in attenuation is due to photoelectric absorption of the photons. For this interaction to occur, the photons have more energy than the binding energy of the K shell electrons. A photon having an energy just above the binding energy of the electron is therefore more likely to be absorbed than a photon having an energy just below this binding energy. A general term for the phenomenon is absorption edge.

Exemplary decomposition algorithms used to generate atomic number and density information from the energy sensitive x-ray measurements stem from an assumption that any material's attenuation properties may be approximated by the linear combination of two other materials. The attenuation of materials in the CT energy range (˜10-200 keV) is dominated by two physical processes: the photo-electric effect and Compton scattering. Materials with a K-edge in this energy range exhibit a discontinuity in their attenuation function. Employment of only two basis materials provides an inadequate description of this discontinuity.

The two material basis decomposition approach assumes that K-edge materials are excluded. Practically, however, many dual energy systems are designed with very broad energy spectra. The error due to the incorrect application of the basis material assumption is very small when these broad energy spectra are used. Exemplary basis function decomposition algorithms ignore the error even when K-edge materials are used. However with highly resolving energy discriminating detectors, or narrow energy spectrums applied to a dual energy system, this error is non-negligible and will contribute to erroneous density and atomic number values.

Therefore, it would be desirable to design an apparatus and method that increase accuracy of decomposition of energy dependent projection data in a presence of K-edge material.

### BRIEF DESCRIPTION OF THE INVENTION

The present invention is a directed method and apparatus for basis material decomposition that overcomes the aforementioned drawbacks. A computer is programmed to generate corresponding sets of projection values for three or more energy spectra through employment of attenuation coefficients of three or more basis materials to simulate responses of the diagnostic imaging system to a plurality of lengths of the three or more basis materials wherein the three or more basis materials comprise two or more non K-edge basis materials and one or more K-edge basis materials.

In accordance with one aspect of the present invention, a diagnostic imaging system includes a high frequency electromagnetic energy source that emits a beam of high frequency electromagnetic energy toward an object to be imaged, a detector that receives high frequency electromagnetic energy emitted by the high frequency electromagnetic energy source, and a data acquisition system (DAS) operably connected to the detector. A computer is operably connected to the DAS and is programmed to generate corresponding sets of projection values for three or more energy spectra through employment of attenuation coefficients of three or more basis materials to simulate responses of the diagnostic imaging system to a plurality of lengths of the three or more basis materials wherein the three or more basis materials comprise two or more non K-edge basis materials and one or more K-edge basis materials.

According to another aspect of the present invention, a diagnostic imaging system includes a high frequency electromagnetic energy source that emits a beam of high frequency electromagnetic energy toward an object to be imaged, a detector that receives high frequency electromagnetic energy emitted by the high frequency electromagnetic energy source, and a data acquisition system (DAS) operably connected to the detector. A computer is operably connected to the DAS and is programmed to generate a first projection set of the object at a first energy level, a second projection set of the object at a second energy level, and a third projection set of the object at a third energy level. The computer is also programmed to generate a set of projection values for each of a plurality of electromagnetic energy spectra using at least one component characteristic the diagnostic imaging system and attenuation coefficients for at least two or more non K-edge basis materials and for at least one or more K-edge basis materials to simulate responses of the diagnostic imaging system to a plurality of lengths of the at least two or more non K-edge basis materials and the at least one or more K-edge basis materials.

In accordance with yet another one aspect of the present invention, a method basis material decomposition includes selecting first and second non K-edge basis materials with respective first and second attenuation coefficients and selecting a K-edge basis material with a third attenuation coefficient. The method also includes generating corresponding sets of projection values for a plurality of energy spectra through employment of the first, second, and third attenuation coefficients to simulate responses of one or more of an energy discriminating (ED), multi energy (ME), and/or dual energy (DE) CT imaging system to a plurality of lengths of the first and second non K-edge basis materials and the K-edge basis material.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a pictorial view of a CT imaging system.

FIG. 2 is a block schematic diagram of the system illustrated in FIG. 1.

FIG. 3 is a perspective view of one embodiment of a CT system detector array.

FIG. 4 is a flowchart depicting steps for material decomposition that comprises employment of K-edge contrast materials according to an embodiment of the present invention.

FIG. 5 is a flowchart depicting steps for generating a basis material decomposition table or function in accordance with one embodiment of the present invention.

FIG. 6 is a flowchart depicting steps for generating a density map in accordance with one embodiment of the present invention.

FIG. 7 is a pictorial view of a CT system for use with a non-invasive package inspection system.

### DETAILED DESCRIPTION OF THE PREFERRED EMBODIMENT

Exemplary diagnostics devices comprise x-ray systems, magnetic resonance (MR) systems, ultrasound systems, computed tomography (CT) systems, positron emission tomography (PET) systems, and other types of imaging systems. Exemplary applications of x-ray sources comprise imaging, medical, security, and industrial inspection applications. The operating environment of the present invention is described with respect to a sixty-four-slice computed tomography (CT) system. However, it will be appreciated by those skilled in the art that the present invention is equally applicable for use with other multi-slice configurations. Moreover, the present invention will be described with respect to the detection and conversion of x-rays. However, one skilled in the art will further appreciate that the present invention is equally applicable for the detection and conversion of other high frequency electromagnetic energy. The present invention will be described with respect to a “third generation” CT scanner, but is equally applicable with other CT systems.

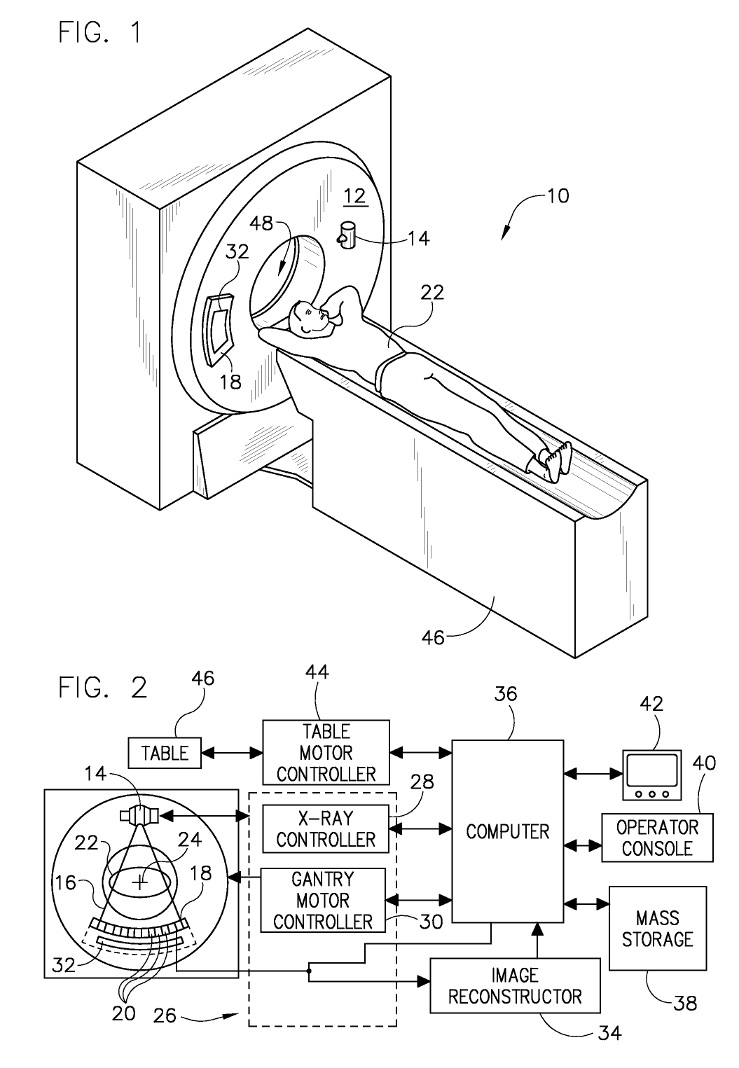

Referring to FIG. 1, a computed tomography (CT) imaging system 10 is shown as including a gantry 12 representative of a “third generation” CT scanner. The CT system 10 in an example comprises an energy discriminating (ED), multi energy (ME), and/or dual energy (DE) CT imaging system that may be referred to as an EDCT, MECT, and/or DECT imaging system. Referring now to FIG. 2, detector assembly 18 is formed by a plurality of detectors 20 and data acquisition systems (DAS) 32. The plurality of detectors 20 sense the projected x-rays that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patients 22 through a gantry opening 48 of FIG. 1 in whole or in part.

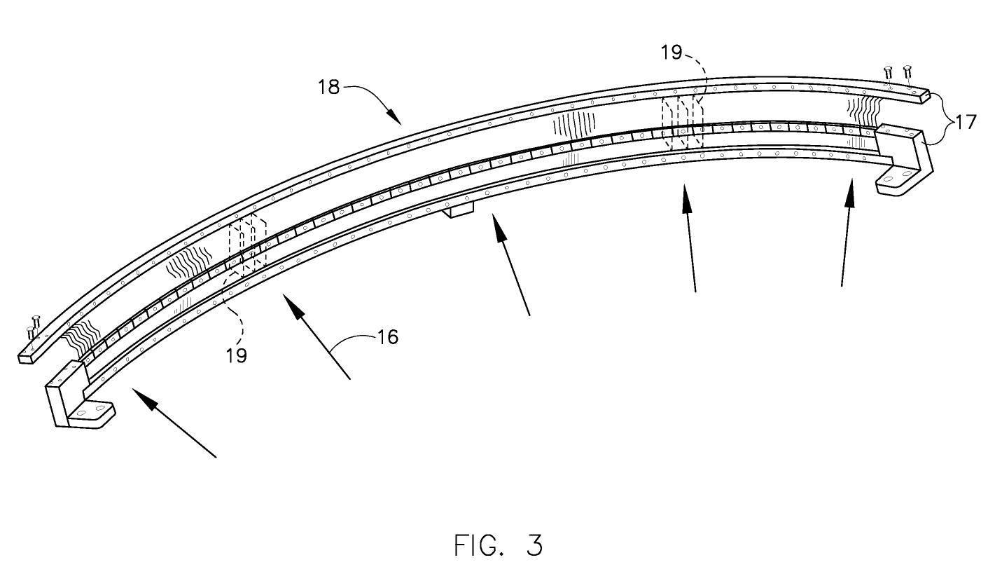

As shown in FIG. 3, detector assembly 18 includes rails 17 having collimating blades or plates 19 placed therebetween. Plates 19 are positioned to collimate x-rays 16 before such beams impinge upon, for instance, detector 20 of FIG. 2 positioned on detector assembly 18. In one embodiment, detector assembly 18 includes 57 detectors 20, each detector 20 having an array size of 64×16 of pixel elements 50. As a result, detector assembly 18 has 64 rows and 912 columns (16×57 detectors) which allows 64 simultaneous slices of data to be collected with each rotation of gantry 12.

EDCT/MECT/DECT provides energy discrimination and material characterization. For example, in the absence of object scatter and in the absence of K-edge materials, the system derives the behavior at any other energy based on the signal from two regions of photon energy in the spectrum: the low-energy and the high-energy portions of the incident x-ray spectrum. In an exemplary energy region of medical CT, two physical processes dominate the x-ray attenuation: (1) Compton scatter and the (2) photoelectric effect. The detected signals from two energy regions provide sufficient information to resolve the energy dependence of the material being imaged. Furthermore, detected signals from the two energy regions provide sufficient information to determine the relative composition of an object composed of two materials.

An illustrative discussion is now presented in connection with an exemplary implementation of a decomposition algorithm. An image or slice is computed which may incorporate, in certain modes, less or more than 360 degrees of projection data, to formulate an image. The image may be collimated to desired dimensions, using tungsten shutters or plates 19 in front of the x-ray source 14 and different detector apertures. A collimator typically defines the size and shape of the beam of x-rays 16 that emerges from the x-ray source 14. A bowtie filter (not shown) may be included in the system 10 to further control the dose to the patient 22. An exemplary bowtie filter pre-attenuates the beam of x-rays 16 to accommodate the body part being imaged, such as head or torso, such that, in general, less attenuation is provided for x-rays passing through or near an isocenter of the patient 22. The bowtie filter in an example shapes the x-ray intensity during imaging in accordance with the region of interest (ROI), field of view (FOV), and/or target region of the patient 22 being imaged.

As the x-ray source 14 and the detector array 18 rotate, the detector array 18 collects data of the attenuated x-ray beams. The data collected by the detector array 18 undergo pre-processing and calibration to condition the data to represent the line integrals of the attenuation coefficients of the scanned object or the patient 22. The processed data are commonly called projections.

In exemplary EDCT/MECT/DECT, two or more sets of projection data are obtained for the imaged object at different tube voltages or different x-ray spectra or, alternatively, at a single tube voltage or spectrum with an energy resolving detector of the detector array 18. The acquired sets of projection data may be used for basis material decomposition (BMD). During BMD, the measured projections are converted to a set of density line-integral projections. The density line-integral projections may be reconstructed to form a density map or image of each respective basis material, such as bone, soft tissue, and/or contrast agent maps. The density maps or images may be, in turn, associated to form a volume rendering of the basis material, for example, bone, soft tissue, and/or contrast agent, in the imaged volume.

Once reconstructed, the basis material image produced by the CT system 10 reveals internal features of the patient 22, expressed in the densities of the three basis materials. The density image may be displayed to show these features. In traditional approaches to diagnosis of medical conditions, such as disease states, and more generally of medical events, a radiologist or physician would consider a hard copy or display of the density image to discern characteristic features of interest. Such features might include lesions, sizes, and shapes of particular anatomies or organs, and other features that would be discernable in the image based upon the skill and knowledge of the individual practitioner.

A K-edge indicates a sudden increase in the attenuation coefficient of photons occurring at a photon energy just above the binding energy of a K shell electron of the atoms interacting with the photons. The sudden increase in attenuation is due to photoelectric absorption of the photons. For this interaction to occur, the photons have more energy than the binding energy of the K shell electrons. A photon having an energy just above the binding energy of the electron is, therefore, more likely to be absorbed than a photon having an energy just below this binding energy. Sudden increases in attenuation may also be found for inner shells other than the K shell. A general term for the phenomenon is absorption edge.

A previous two-material basis decomposition approach assumes that K-edge materials are excluded. Practically, however, many dual energy systems are designed with very broad energy spectra. The error due to the incorrect application of the basis material assumption is very small when these broad energy spectra are used. Exemplary basis function decomposition algorithms ignore the error even when K-edge materials are used. However, with highly resolving energy discriminating detectors, or narrow energy spectrums applied to a dual energy system, or with new contrast agents that have K-edges in a more sensitive part of the energy spectrum, this error is non-negligible and will contribute to erroneous density and atomic number values.

An exemplary approach increases accuracy in determination of material density and atomic number information by using energy specific x-ray projection data of an object that is known to contain materials that have a K-edge in the detectable energy range of the system. An exemplary approach is applicable to MECT/EDCT X-ray systems and CT systems with energy discrimination capability, measuring either medical-relevant or industrial-relevant objects. For illustrative purposes, a specific medical application is discussed where a contrast agent with K-edge materials is administered. The contrast agent may be non-specific or targeted to a particular anatomy or function. An exemplary algorithm is proposed for the decomposition of energy dependent projection data into three material basis functions where one of the basis functions consists of a K-edge material. Employment of a K-edge material as one of the basis functions can achieve more accurate results than using only two materials.

In addition to a CT number or Hounsfield value, an energy selective CT system can provide additional information related to a material's atomic number and density. This information is quite useful for several medical clinical applications where the CT number may be similar but the material's atomic number may be quite different such as in calcified plaque and iodinated blood in coronary arteries or other vessels. Many of these clinical applications involve intravenous or orally administered contrast agents. Typically, contrast agents contain materials with high atomic number (high Z) are selected because a small amount of material is highly radio-opaque and will therefore induce a high contrast. Another trend of high atomic number materials is that they typically exhibit a K-edge in the region of x-ray sensitivity. Exemplary contrast agents exhibiting a K-edge include barium (Ba), iodine (I), gadolinium (Gd), and the like. Exemplary development of contrast materials has focused on targeted agents that collect in the patient only in targeted cells or targeted cell functions. Since the uptake in the targeted regions may be small compared to intravenous administered contrast agents, the contrast enhancement may be small; therefore, it may be more important to distinguish areas of low concentration, high Z (high atomic number) materials from natural materials in the body. An exemplary decomposition algorithm generates atomic number and density information from the energy sensitive x-ray measurements.

As an exemplary assumption, the attenuation as a function of energy of any material or composition can be described as the linear combination of the attenuation of two basis materials and one K-edge material. K-edge materials do not occur naturally in the human body, but typically administered contrast agents do contain K-edge materials.

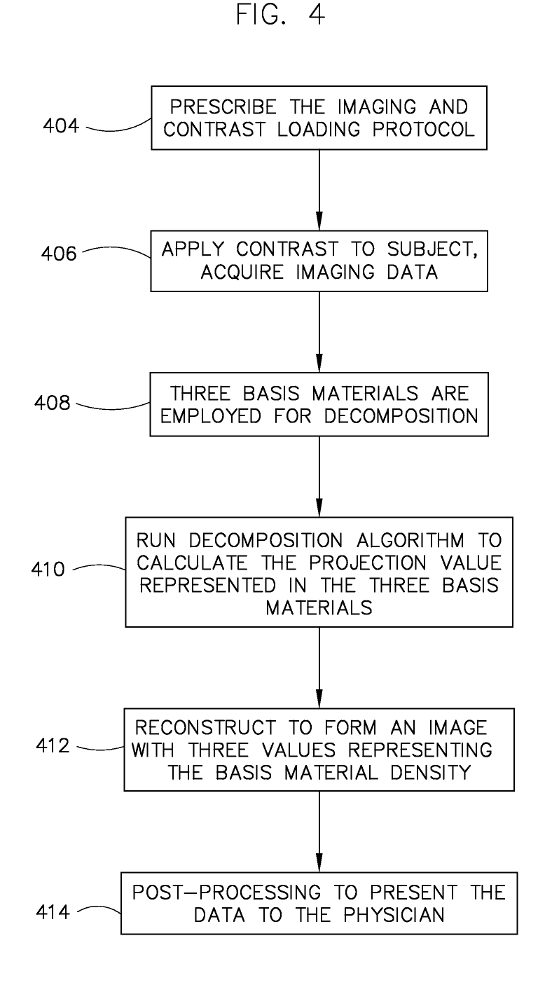

FIG. 4 is a representation of exemplary logic 402 for material decomposition that comprises employment of K-edge contrast materials. STEP 404 prescribes the imaging and contrast loading protocol. An exemplary implementation employs a gadolinium based contrast agent such as gadodiamide. STEP 406 applies the contrast agent to the patient 22 as the subject, and acquires imaging data. X-ray projection data is acquired for three energy bins. The selection of the energy range of the energy bins may be accomplished by any number of procedures. Measurements, in an example, may be acquired by changing the incident energy of a monochromatic source as the x-ray source 14. Measurements, in another example, may be acquired by adjusting the incident spectrum through changing a maximum potential (kVp) of the x-ray source 14. Measurements, in another example, may be acquired by the addition of filters before or after the x-ray photons encounter the patient 22, or energy selective detectors. The energy bins may have some overlap in energy range sensitivity.

STEP 408 selects three basis materials for decomposition. Two materials, for example, water and calcium, are selected that span the expected atomic number in the patient 22. These two basis materials are used to properly account for the two physical processes that dominate the x-ray attenuation: (1) Compton scatter and (2) the photoelectric effect. The third material is selected that comprises a K-edge material that matches the material used in the applied contrast material. A basis material system in an example employs any two distinctive materials such as water and calcium and a K-edge material. If a contrast material is known to contain a certain K-edge element, then one selects that K-edge element as the third material. For example, one selects gadolinium as the main element in the contrast material gadodiamide.

STEP 410 runs an exemplary decomposition algorithm to calculate the projection value represented in the three basis materials. Additional illustrative description of the exemplary decomposition algorithm appears further below. STEP 412 performs reconstruction to form an image with three values representing the basis material density. STEP 414 employs any number of post-processing techniques to present the data to the physician. For example, the data may be immediately displayed to the physician on a computer monitor or similar device. The data may also be printed out on paper or stored to a computer memory device for later retrieval for displaying or printing.

An illustrative description of the exemplary decomposition algorithm is now presented, for explanatory purposes. Exemplary processing of the measured projection data to generate a density image involves a BMD process. The respective attenuation coefficients associated with the basis materials in an example are employed in conjunction with the characteristics of the CT system to simulate the system's energy response for varying x-ray path lengths. Specifically, for each energy bin chosen, the projection data for a varying x-ray path length is predicted by modeling the x-ray tube, basis material, and the detector energy response, and optionally any other system component found to have an energy dependent response. The BMD process may be accomplished using a BMD conversion table or function that accounts for the system characteristics. The BMD conversion table or function may thereby accurately represent realistic system response. The BMD conversion table or function may be pre-generated, so BMD may be accomplished rapidly and without iteration to arrive at an acceptable solution set. In another example, one may make careful measurements of the three materials at different path lengths.

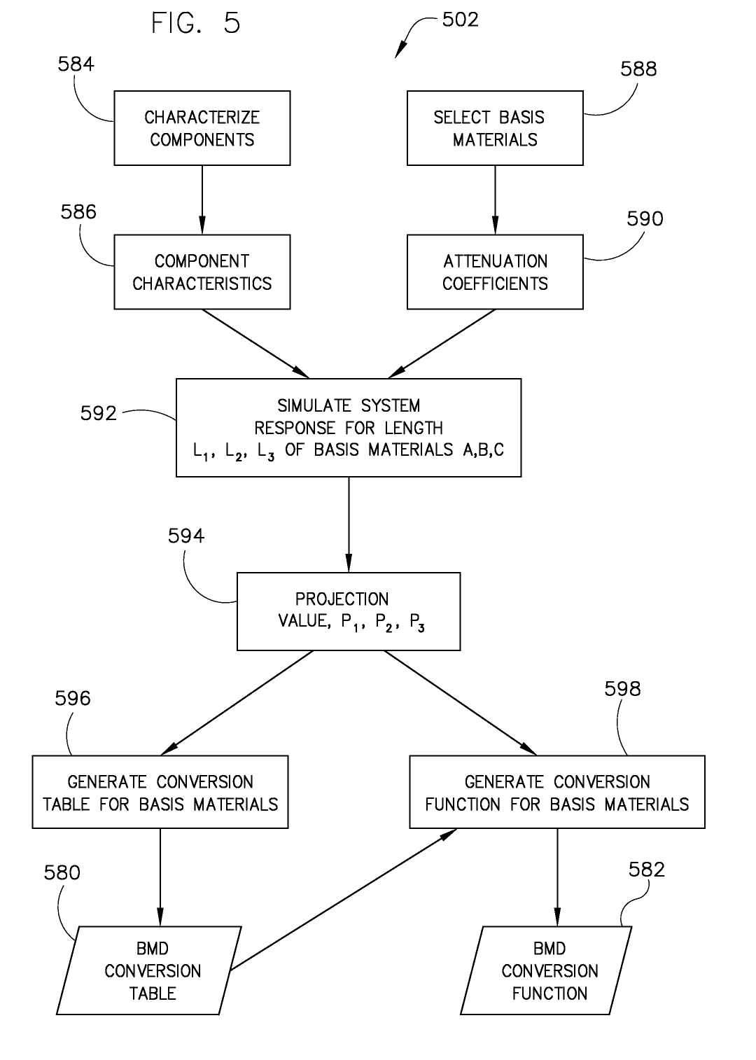

FIG. 5 is a representation of exemplary logic 502 for generation of a BMD conversion table 580 or function 582. STEP 584 characterizes one or more components of the CT system 10. The components to be characterized may include, but are not limited to, the detector array 18, the x-ray source 14, a filter, the DAS 32, and so forth. Examples of component characteristics 586 include, but are not limited to, the x-ray spectrum, the beam filter, the detector response, the x-ray energy level, and the peak kilovoltage (kVp). The component characteristics 586 relate to the configuration of the CT system 10 and provide information that may be used to determine realistic system responses.

STEP 588 selects for simulation an exemplary basis material system that comprises two non K-edge materials and a K-edge material. Exemplary non K-edge materials comprise bone, soft tissue, or a pair of other distinctive materials. The third material comprises a K-edge material that matches the material used in the applied contrast material.

STEP 592 simulates the system response for varying lengths, L, of the three basis materials through employment of respective attenuation coefficients 590 associated with the three basis materials, in conjunction with the component characteristics 586. As depicted at STEP 592, L1, L2, and L3 represent the varying lengths of the different bases, respectively. The simulation process may be based upon known mathematical principles in which the respective component characteristics 586 and attenuation coefficients 590 are modeled to generate respective projection values, P, at STEP 594 for each length, L. STEP 592 may simulate various lengths such that the entire dynamic range of the CT system 10 is covered, though less than the dynamic range may also be simulated.

The exemplary decomposition algorithm generates a projection value, P, for each length, L, as a function of the three basis materials. A projection value is obtained by predicting or measuring the attenuation through the chosen basis materials, L1, L2 and L3, where the basis materials' densities are known. The procedure is repeated to obtain a projection value for each of the energy bins selected. Various lengths are simulated such that the entire dynamic range of the system is covered.

Once a set of projection values is obtained for the respective lengths of basis material covering the desired range, STEP 596 generates a conversion table 580. So, once the sets of projection values 594 are obtained for the respective lengths of the basis materials covering the desired dynamic range, the BMD conversion table 580 may be generated. The conversion table 580 relates a projection value that corresponds to the energy bins P1, PH2, and P3 selected, to a length of basis material (L1, L2, L3) based upon the various CT system characteristics and the attenuation coefficient of the basis material, where P1, P2, and P3 are the projection values at the energy spectrum of the three energy bins. So, the BMD conversion table 580 may relate a projection value 594 to a length of a basis material based upon the various component characteristics 586 and the attenuation coefficient 590 of the basis material.

By inverting the input and output, one can generate the conversion table 580. The projection values of each energy bins P1, P2, and P3 are correlated to the length of basis material (L1, L2, L3) through the generated conversion table 580. The data triad (L1, L2, L3) is the integrated lengths for the basis material, which can be directly associated with the integrated densities for the basis material if one prefers to obtain the density map for the reconstructed images. To facilitate the conversion process, the BMD conversion table 580 may include interpolated projection values 594 that are evenly and incrementally spaced in the table 580.

The retrieved density line integral projections are then reconstructed to generate density maps or images of the three materials. The accuracy of the results of material decomposition is controlled by the accuracy of the basis materials to represent any material in the body. Through the system simulation process, input data triads (L1, L2, L3) and the simulated energy spectra generate respective output projection values (P1, p2, and P3), where P1, P2 and P3 are the projection values generated each of the energy spectrum.

STEP 598 may generate a BMD conversion function 582 in addition to or in place of the conversion table 580. For example, the conversion table 580 may be surface fitted with a high-order polynomial to generate the conversion function 582. In another example, a high-order polynomial may be fitted directly to the projection values 594, component characteristics 586, and attenuation coefficient 590 to generate the BMD conversion function 582. In a further example, such as when a bowtie filter is present in the CT system 10, a separate conversion table 580 or function 582 may be generated for each detector element 20 of the detector array 18.

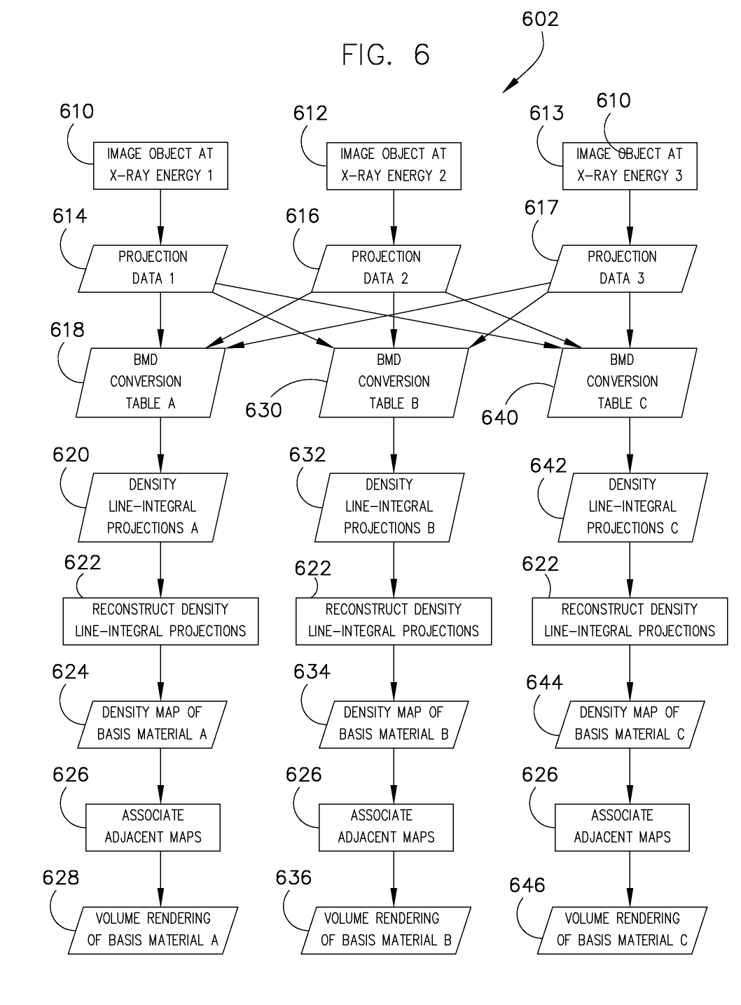

FIG. 6 is a representation of exemplary logic 602 for employment of the BMD conversion table 580, and/or the BMD conversion function 582, to determine a density line-integral projection set for the basis material from a measured projection set and the component characteristics 586 of the CT system 10 at the time of measurement. STEP 610, 612, and 613 image the object or patient 22 to produce first, second, and third sets of projection data 614, 616, 617, respectively. An energy resolving detector such as the detector array 18 serves to associate a measured energy level with each detected photon. For example, the first, second, and third X-ray energy levels typically correspond to distinct X-ray spectra that are differentially attenuated by the basis materials of interest. Alternately, the object or patient may be imaged at a single X-ray spectrum using an energy resolving detector capable of associating a measured energy level with each detected photon. While measurements are depicted as being made using three X-ray energy levels, measurements may be made using additional X-ray energy levels if desired, for example, when x-ray scatter becomes significant.

The projection values of the first, second, and third projection data sets 614, 616, 617 may be searched for in the BMD conversion table 618 associated with basis material A and the corresponding density line integral projections 620 retrieved from the table 618. STEP 622 reconstructs the retrieved density line integral projections 620, such as by filtered backprojection, to generate a density map 624 or image of basis material A. The density map corresponds to the presence of the basis material, such as bone, soft tissue, or contrast agent, at the axial position represented by the projections. STEP 626 may associate density maps for proximate or adjacent axial positions, or z-locations, to generate a volume rendering 628 of basis material A for the imaged volume. While the described conversion table 618 represents one mechanism of generating density line integrals 620 from the projection data 614, 616, 617, one of ordinary skill in the art will readily understand that the conversion function 582 may also be used.

Similarly, the projection values of the first, second, and third projection data sets 614, 616, 617 may be searched for in the BMD conversion table 630 associated with basis material B and the corresponding density line integral projections 632 retrieved from the table 630. A corresponding density map 634 of basis material B may be reconstructed and, if desired, proximate or adjacent density maps 622 may be associated to form a volume rendering 636 of basis material B for the imaged volume.

Also, the projection values of the first, second, and third projection data sets 614, 616, 617 may be searched for in the BMD conversion table 640 associated with K-edge basis material C and the corresponding density line integral projections 642 retrieved from the table 640. A corresponding density map 644 of K-edge basis material C may be reconstructed and, if desired, proximate or adjacent density maps 622 may be associated to form a volume rendering 646 of K-edge basis material C for the imaged volume.

In addition, using the combined information from the basis material conversion tables 618, 630, 640 the projection data from the projection data sets 614, 616, 617 may be processed to generate density line integral projections for basis materials D, E, F and so forth, including K-edge basis materials. In an example, the density of other basis materials may be represented as a combination of the density information associated with the basis materials A, B, and C, so the information contained with the conversion tables 618, 630, 640 may be combined to generate the density line integral projections associated with other basis materials. An exemplary BMD decomposition technique may decompose the photoelectric and Compton components for an imaged material. So, images corresponding to the photoelectric or Compton components of the imaged material may be generated in addition to or instead of the density based images.

An exemplary use of the K-edge material decomposition is to decrease the errors involved in material decomposition when contrast agents are employed. An exemplary approach improves the accuracy when K-edge materials are used as contrast agents. For example, if the contrast agent gadodiamide is represented as a linear combination of water and calcium over the energy range of 1-200 keV, a root mean square (rms) error of approximately 9.6e3 results. However, if gadolinium (Gd) is used as a third, K-edge material, the rms error is reduced by 95% to approximately 443. These errors are propagated to the reconstructed density maps and the propagated error is specifically dependent on the energy system used to acquire the two energy bins.

An exemplary algorithm uses three basis materials for decomposition where one of the materials is a K-edge material. An exemplary system selects the basis materials to be used in the decomposition based on a priori knowledge of what contrast agent, containing K-edge materials, is used (either targeted or non-specific).

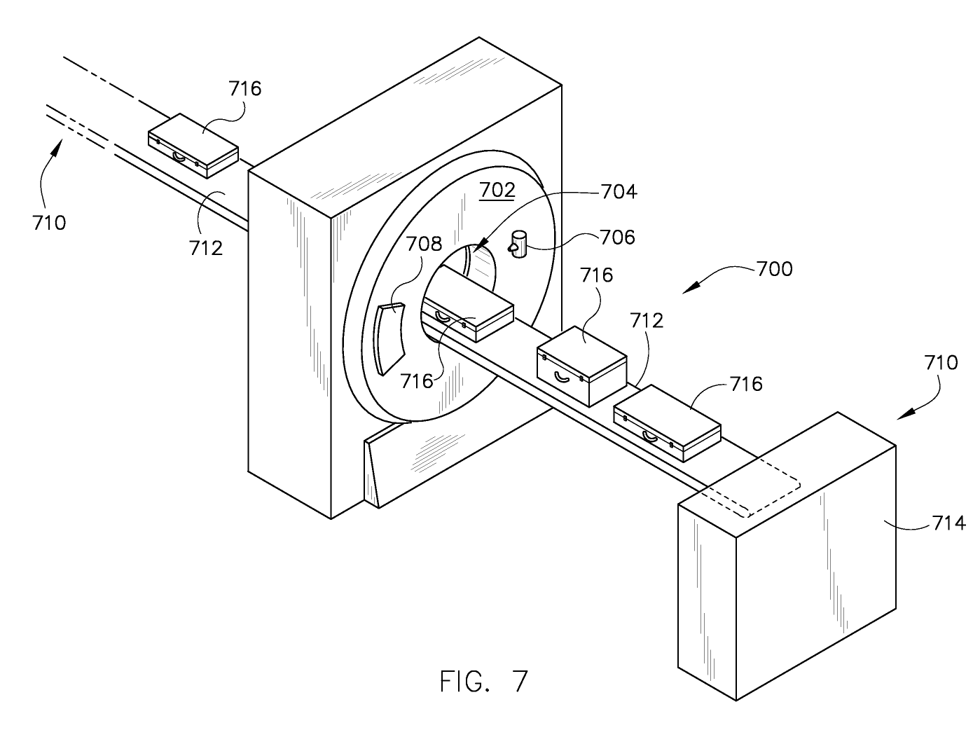

Referring now to FIG. 7, package/baggage inspection system 700 includes a rotatable gantry 702 having an opening 704 therein through which packages or pieces of baggage may pass. The rotatable gantry 702 houses an x-ray and/or high frequency electromagnetic energy source 706 as well as a detector assembly 708 having scintillator arrays comprised of scintillator cells. A conveyor system 77 is also provided and includes a conveyor belt 712 supported by structure 714 to automatically and continuously pass packages or baggage pieces 716 through opening 704 to be scanned. Objects 716 are fed through opening 704 by conveyor belt 712, imaging data is then acquired, and the conveyor belt 712 removes the packages 716 from opening 704 in a controlled and continuous manner. As a result, postal inspectors, baggage handlers, and other security personnel may non-invasively inspect the contents of packages 716 for explosives, knives, guns, contraband, etc.

An implementation of the system 10 and/or 700 in an example comprises a plurality of components such as one or more of electronic components, hardware components, and/or computer software components. A number of such components can be combined or divided in an implementation of the system 10 and/or 700. An exemplary component of an implementation of the system 10 and/or 700 employs and/or comprises a set and/or series of computer instructions written in or implemented with any of a number of programming languages, as will be appreciated by those skilled in the art. An implementation of the system 10 and/or 700 in an example comprises any (e.g., horizontal, oblique, or vertical) orientation, with the description and figures herein illustrating an exemplary orientation of an implementation of the system 10 and/or 700, for explanatory purposes.

An implementation of the system 10 and/or the system 700 in an example employs one or more computer readable signal bearing media. A computer-readable signal-bearing medium in an example stores software, firmware and/or assembly language for performing one or more portions of one or more implementations. An example of a computer-readable signal bearing medium for an implementation of the system 10 and/or the system 700 comprises the recordable data storage medium of the image reconstructor 34, and/or the mass storage device 38 of the computer 36. A computer-readable signal-bearing medium for an implementation of the system 10 and/or the system 700 in an example comprises one or more of a magnetic, electrical, optical, biological, and/or atomic data storage medium. For example, an implementation of the computer-readable signal-bearing medium comprises floppy disks, magnetic tapes, CD-ROMs, DVD-ROMs, hard disk drives, and/or electronic memory. In another example, an implementation of the computer-readable signal-bearing medium comprises a modulated carrier signal transmitted over a network comprising or coupled with an implementation of the system 10 and/or the system 700, for instance, one or more of a telephone network, a local area network (“LAN”), a wide area network (“WAN”), the Internet, and/or a wireless network.

The steps or operations described herein are examples. There may be variations to these steps or operations without departing from the spirit of the invention. For example, the steps may be performed in a differing order, or steps may be added, deleted, or modified.

In accordance with one embodiment of the present invention, a diagnostic imaging system includes a high frequency electromagnetic energy source that emits a beam of high frequency electromagnetic energy toward an object to be imaged, a detector that receives high frequency electromagnetic energy emitted by the high frequency electromagnetic energy source, and a data acquisition system (DAS) operably connected to the detector. A computer is operably connected to the DAS and is programmed to generate corresponding sets of projection values for three or more energy spectra through employment of attenuation coefficients of three or more basis materials to simulate responses of the diagnostic imaging system to a plurality of lengths of the three or more basis materials wherein the three or more basis materials comprise two or more non K-edge basis materials and one or more K-edge basis materials.

According to another embodiment of the present invention, a diagnostic imaging system includes a high frequency electromagnetic energy source that emits a beam of high frequency electromagnetic energy toward an object to be imaged, a detector that receives high frequency electromagnetic energy emitted by the high frequency electromagnetic energy source, and a data acquisition system (DAS) operably connected to the detector. A computer is operably connected to the DAS and is programmed to generate a first projection set of the object at a first energy level, a second projection set of the object at a second energy level, and a third projection set of the object at a third energy level. The computer is also programmed to generate a set of projection values for each of a plurality of electromagnetic energy spectra using at least one component characteristic the diagnostic imaging system and attenuation coefficients for at least two or more non K-edge basis materials and for at least one or more K-edge basis materials to simulate responses of the diagnostic imaging system to a plurality of lengths of the at least two or more non K-edge basis materials and the at least one or more K-edge basis materials.

In accordance with yet another one embodiment of the present invention, a method basis material decomposition includes selecting first and second non K-edge basis materials with respective first and second attenuation coefficients and selecting a K-edge basis material with a third attenuation coefficient. The method also includes generating corresponding sets of projection values for a plurality of energy spectra through employment of the first, second, and third attenuation coefficients to simulate responses of one or more of an energy discriminating (ED), multi energy (ME), and/or dual energy (DE) CT imaging system to a plurality of lengths of the first and second non K-edge basis materials and the K-edge basis material.

The present invention has been described in terms of the preferred embodiment, and it is recognized that equivalents, alternatives, and modifications, aside from those expressly stated, are possible and within the scope of the appending claims.

What is claimed is:

1. A diagnostic imaging system comprising:
a high frequency electromagnetic energy source that emits a beam of high frequency electromagnetic energy toward an object to be imaged;
a detector that receives high frequency electromagnetic energy emitted by the high frequency electromagnetic energy source;
a data acquisition system (DAS) operably connected to the detector; and
a computer operably connected to the DAS and programmed to:
generate corresponding sets of projection values for three or more energy spectra through employment of attenuation coefficients of three or more basis materials to simulate responses of the diagnostic imaging system to a plurality of lengths of the three or more basis materials;
wherein the three or more basis materials comprise two or more non K-edge basis materials and one or more K-edge basis materials.

2. The diagnostic imaging system of claim 1 wherein the computer operably connected to the DAS is programmed to:
characterize one or more components of the diagnostic imaging system to obtain one or more component characteristics; and
generate one of a table and a function through employment of the sets of projection values and the one or more component characteristics.

3. The diagnostic imaging system of claim 2 wherein the computer operably connected to the DAS is programmed to characterize one of the high frequency electromagnetic energy source and the detector to obtain one or more of the one or more component characteristics.

4. The diagnostic imaging system of claim 2 wherein the computer operably connected to the DAS is programmed to determine a density line integral projection set for one of the basis materials through employment of a measured projection set and the one of the table and the function.

5. The diagnostic imaging system of claim 4 wherein the computer operably connected to the DAS is programmed to reconstruct the density line integral projection set to form a map.

6. The diagnostic imaging system of claim 1 wherein the two or more non K-edge basis materials comprise two or more materials selected from the group consisting of bone, calcium, soft tissue, and water.

7. The diagnostic imaging system of claim 1 wherein the one or more K-edge basis materials match material employed in contrast material applied in connection with the object.

8. The diagnostic imaging system of claim 1 wherein the one or more K-edge basis materials comprise at least one material selected from the group consisting of barium (Ba), iodine (I), and gadolinium (Gd).

9. The diagnostic imaging system of claim 1 wherein the computer operably connected to the DAS is programmed to employ the plurality of lengths of the three or more basis materials to represent the dynamic range of the diagnostic imaging system.

10. The diagnostic imaging system of claim 1 wherein the computer operably connected to the DAS is programmed to employ interpolation to obtain one or more of the sets of projection values for the two or more energy spectra.

11. A diagnostic imaging system comprising:
a high frequency electromagnetic energy source that emits a beam of high frequency electromagnetic energy toward an object to be imaged;
a detector that receives high frequency electromagnetic energy emitted by the high frequency electromagnetic energy source;
a data acquisition system (DAS) operably connected to the detector; and
a computer operably connected to the DAS and programmed to:
generate a first projection set of the object at a first energy level;
generate a second projection set of the object at a second energy level;
generate a third projection set of the object at a third energy level;
generate a set of projection values for each of a plurality of electromagnetic energy spectra using at least one component characteristic the diagnostic imaging system and attenuation coefficients for at least two or more non K-edge basis materials and for at least one or more K-edge basis materials to simulate responses of the diagnostic imaging system to a plurality of lengths of the at least two or more non K-edge basis materials and the at least one or more K-edge basis materials.

12. The diagnostic imaging system of claim 11 wherein the computer operably connected to the DAS is programmed to generate a line-integral projection set through employment of the sets of projection values and through one or more of a basis material decomposition table or function.

13. The diagnostic imaging system of claim 11 wherein the computer operably connected to the DAS is programmed to generate a line-integral projection set through employment of the sets of projection values and through one or more of a basis material decomposition table or function that correspond to the at least two or more non K-edge basis materials and the at least one or more K-edge basis materials.

14. The diagnostic imaging system of claim 13 wherein the computer operably connected to the DAS is programmed to reconstruct the line-integral projection set to form corresponding three or more density maps of the at least two or more non K-edge basis materials and the at least one or more K-edge basis materials.

15. The diagnostic imaging system of claim 14 wherein the computer operably connected to the DAS is programmed to associate adjacent density maps of the three or more density maps to form a volume rendering.

16. The diagnostic imaging system of claim 11 wherein the computer operably connected to the DAS is programmed to:
generate a density line-integral projection set for each of the at least two or more non K-edge basis materials and the at least one or more K-edge basis materials through employment of the sets of projection values and through one or more of a basis material decomposition table or function that correspond to the at least two or more non K-edge basis materials and the at least one or more K-edge basis materials; and
reconstruct each of the density line-integral projection sets to form corresponding three or more density maps of the at least two or more non K-edge basis materials and the at least one or more K-edge basis materials.

17. The diagnostic imaging system of claim 11 wherein the two or more non K-edge basis materials comprise two or more materials selected from the group consisting of bone, calcium, soft tissue, and water.

18. The diagnostic imaging system of claim 11 wherein the at least one or more K-edge basis materials match material employed in contrast material applied in connection with the object.

19. The diagnostic imaging system of claim 11 wherein the at least one or more K-edge basis materials comprise one or more materials selected from the group consisting of barium (Ba), iodine (I), and gadolinium (Gd).

20. A method basis material decomposition comprising the steps of:
selecting first and second non K-edge basis materials with respective first and second attenuation coefficients;
selecting a K-edge basis material with a third attenuation coefficient; and
generating corresponding sets of projection values for a plurality of energy spectra through employment of the first, second, and third attenuation coefficients to simulate responses of one or more of an energy discriminating (ED), multi energy (ME), and/or dual energy (DE) CT imaging system to a plurality of lengths of the first and second non K-edge basis materials and the K-edge basis material.

21. The method of claim 20 further comprising the step of:
characterizing one or more components of the one or more of the EDCT, MECT, and/or DECT imaging system to obtain one or more component characteristics;
wherein the step of generating the corresponding sets of projection values comprises generating the corresponding sets of projection values for the plurality of energy spectra through employment of the one or more component characteristics and the first, second, and third attenuation coefficients to simulate the responses of the EDCT, MECT, and/or DECT imaging system to the plurality of lengths of the first and second non K-edge basis materials and the K-edge basis material;
the method further comprising generating one or more of a table and/or a function from the sets of projection values and the one or more component characteristics.
